(19) United States
(12) Patent Application Publication
(10) Pub. No.: US 2018/0217993 A1
(43) Pub. Date: Aug. 2, 2018

(54) AUTHOR TERM AFFINITY

(71) Applicant: Apple Inc., Cupertino, CA (US)

(72) Inventor: Saravana Kumar Siva Kumaran, Fremont, CA (US)

(21) Appl. No.: 15/881,694

(22) Filed: Jan. 26, 2018

Related U.S. Application Data
(60) Provisional application No. 62/527,912, filed on Jun. 30, 2017.
(60) Provisional application No. 62/452,239, filed on Jan. 30, 2017.

(51) Int. Cl. G06F 17/30

(52) U.S. Cl. CPC G06F 17/3053; G06F 17/30554; G06F 17/30867

(57) ABSTRACT

Author-term affinity scores enable search engines to score and rank search results based on a combination of author (domain) influence and anchor text scoring. An anchor text is scored based on the influence of the domains with which it is associated, including the source domain in which the anchor text is cited and the destination domain to which the anchor text is linked. A contribution of each term to an anchor text's score is determined based on how frequently the term occurs overall. Author-term affinity scores are derived from the anchor text scores and saved for use in subsequent searches to rank search results. During searches an author-query affinity based on the previously stored author-term affinity scores enable a search engine to rank search results to improve relevance such that pages of authors having the most influence are presented before pages of authors having less influence.

This application claims the benefit of U.S. Provisional Patent Application No. 62/527,912 filed on Jun. 30, 2017, and also claims the benefit of U.S. Provisional Patent Application No. 62/452,239 filed on Jan. 30, 2017; the present application claims the benefit of these provisional application filing dates under 35 U.S.C. § 119(e) and these provisional applications are hereby incorporated herein by reference in their entirety.

### TECHNICAL FIELD

The technical field relates generally to computerized data processing systems and methods for searching stored data.

### BACKGROUND

Internet searches (e.g. a web search using Bing or Yahoo or Google) often produce a list of search results that includes thousands of items (e.g. web pages). In order to make the search results more useful, search engines typically sort or rank the results based on a metric or characteristic that causes the list to show the items in a particular order.

One way that search engines rank search results is based on an influence score of a domain that provides the item. Domain influence scores can be based on an analysis of links from one domain to another domain, such as when one page hosted by a source domain is hyperlinked to another page hosted by a destination domain. The influence scores are developed by assigning a default minimum influence score to each and every domain in a corpus of domains that provide items such as web pages, and then the default minimum score is updated based on the number of links to a domain.

Another way that search engines rank search results is based on anchor text. Anchor text refers to the clickable text in a web page hosted by a source domain to enable a user to hyperlink to another page hosted by a destination domain.

### SUMMARY OF THE DESCRIPTION

Embodiments of author-term affinity as herein described enable search engines to score and rank search results based on a combination of author influence and anchor texts. Author influence refers to the influence that a particular domain has on the potential relevance of an item in a search result. Anchor texts refer to the clickable text in an item that hyperlinks to another item in a same or different domain. An item refers to a web page or other content hosted by a domain, where the hosting domain is referred to as the author. In some embodiments the author can refer to an originator of a subset of content hosted by a domain.

In any one or more of the embodiments of the systems, apparatuses and methods herein described, a corpus of pages is hosted by a set of domains, the set of domains including source domains and destination domains, a source domain hosting pages containing anchor texts linked to pages hosted by a destination domain.

In one embodiment, anchor texts contained in pages hosted by well-represented source domains are collected so that destination author influence scores can be updated with source author influence scores, where the updating is based on the hyperlinks (also referred to as simply “links”) in the collected anchor texts.

In one embodiment, the updated destination author influence score is used to compute an anchor text score for each anchor text in the collected anchor texts. In a typical embodiment, the anchor text is composed of multiple terms. In one embodiment a contribution of each term in the anchor text to the anchor text's score is determined based on how frequently the term occurs in the corpus of documents. In one embodiment, how frequently a term occurs in the corpus of documents is based on the term's inverse document frequency (IDF). The IDF is a known measure of how much information a term contributes based on whether the term is common or infrequent in a corpus of documents. For example, common terms such as “the” or “to” contribute less information than “unicorn” or “Liechtenstein.” Mathematically, the IDF is expressed as the logarithmically scaled inverse fraction of the documents that contain a term, obtained by dividing the total number of documents by the number of documents containing the term, and then taking the logarithm of that quotient.

In one embodiment, an author-term affinity score between a destination domain and a term in the collected anchor texts is computed based on a contribution of the term to an anchor text's score for all anchor texts in the collected anchor texts in which the term appears. Once computed, the author-term affinity score is stored and maintained in a data repository for future search result ranking.

For example, in one embodiment, a result set of items returned responsive to a query against the corpus can be examined such that each combination of 1) a searched domain hosting a page in the result set of pages, and 2) a query term in the query, are used to lookup the previously computed and stored author-term affinity score.

In one embodiment, the author-query affinity score between the searched domain and the entire query is derived from the sum of the previously computed and stored author-term affinity scores for all of the searched domain and query term combinations present in the result set of items.

In one embodiment, a search engine uses the derived author-query affinity score of a searched domain hosting a page to rank items, e.g. web pages, relative to other items in the result set.

In one embodiment, updating destination author influence scores with source author influence scores is based on the links in the collected anchor texts, including counting the links from the source domains hosting the pages containing anchor texts to the destination domains hosting the linked pages, i.e. the pages to which the anchor text is linked.

In one embodiment, and by way of example only, a page is a web page, including a discreet set of content at a specified URI (Uniform Resource Identifier). In one embodiment, and by way of example only, a domain in the set of domains is defined by a set of web addresses or Uniform Resource Identifiers owned or controlled by an entity. In one embodiment, authors of pages hosted by source domains and destination domains are treated as domains separate from the hosting domain, such as an author of a subset of documents hosted by domain. In one embodiment, a hosting domain includes at least one of social media or social network web sites.

In one embodiment, the computation and storing of the author-term affinity scores includes crawling the Internet to obtain and store the corpus of documents, wherein the computation and scoring is performed offline at periodic intervals and/or on-demand.

The various systems, apparatuses and methods described herein can be performed by one or more data processing systems that obtain or create the corpus and then use the links within the corpus to derive the author-term affinity scores for future search result ranking, including updating the destination domain influence scores based on the anchor texts appearing in the corpus. In one embodiment, the process of deriving author-term affinity scores and updating the destination domain influence scores may be repeated over time as the corpus of items, such as web pages, changes over time.

The various systems, apparatuses and methods described herein can be performed by one or more data processing systems to search the corpus responsive to a query against the corpus, and to rank pages in a result set of pages based upon the derived author-term affinity scores and the terms of the query.

The methods and systems described herein can be implemented by data processing systems, such as server computers, desktop computers and other data processing systems and other consumer electronic devices. The methods and systems described herein can also be implemented by one or more data processing systems which execute executable computer program instructions, stored in one or more non-transitory machine readable media that cause the one or more data processing systems to perform the one or more methods described herein when the program instructions are executed. Thus, the embodiments described herein can include methods, data processing systems, and non-transitory machine-readable media.

The above summary does not include an exhaustive list of all embodiments in this disclosure. All systems and methods can be practiced from all suitable combinations of the various aspects and embodiments summarized above, and also those disclosed in the Detailed Description below.

### BRIEF DESCRIPTION OF THE DRAWINGS

The present invention is illustrated by way of example and not limitation in the figures of the accompanying drawings in which like references indicate similar elements.

FIG. 1 is a block diagram illustrating an overview of an author-term affinity scoring system to score author-term affinity in accordance with one or more embodiments described herein.

FIG. 2 is a block diagram illustrating an overview of an author-query affinity scoring system to rank search results using author-term affinity scores in accordance with one or more embodiments described herein.

FIG. 3 is a flow diagram illustrating processes for an author-term affinity scoring system in accordance with one or more embodiments described herein.

FIG. 4 is a flow diagram illustrating processes for ranking search results using author-term affinity scores in accordance with one or more embodiments described herein.

FIG. 5 is a block diagram illustrating an example of a data processing system that can be used with one or more embodiments described herein.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

A domain that links to or points to another domain contributes or donates a portion of its influence score to the other domain during the process of updating the influence scores. The final result of updating the influence scores produces a data set in which all domains have a positive (non-zero) influence score, with some domains having significantly higher influence scores than other domains.

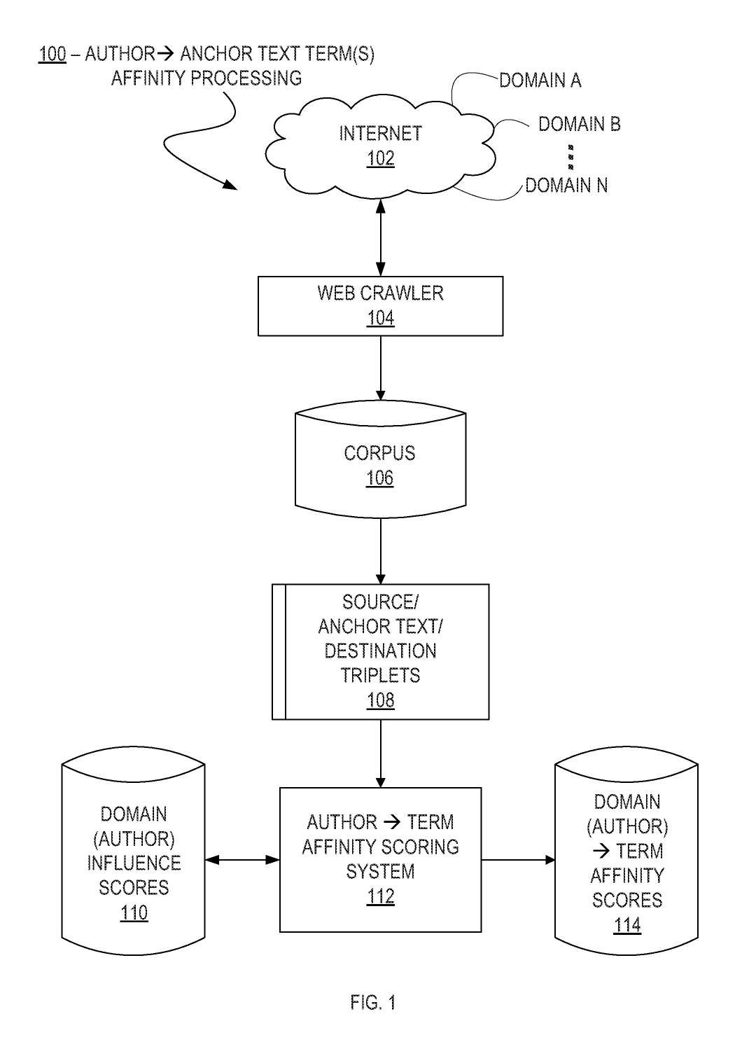

FIG. 1 is a block diagram illustrating an example of one or more data processing systems for creating a corpus of items 106, such as web pages, from a plurality of domains accessible over the Internet 102, e.g. Domain A, Domain B, . . . Domain N. In one embodiment, the pages can be web pages and a domain in the set of domains can be defined by a set of web addresses or Uniform Resource Identifiers owned or controlled by an entity. In one embodiment, each page or item is a discreet set of content at a specified Uniform Resource Identifier.

In one embodiment, a web crawler 104 coupled to the Internet 102 uses conventional and known techniques to crawl the Internet to obtain pages from all the domains, e.g. Domain A, Domain B, . . . Domain N, that are accessible via the Internet. In one embodiment, the web crawler 104 creates the corpus of items 106, including a data structure that describes each crawled domain and the links between domains to determine the number of links to a particular domain from other domains. In one embodiment, the corpus 106 is stored in one or more databases after the web crawler 104 completes the process of crawling the Internet.

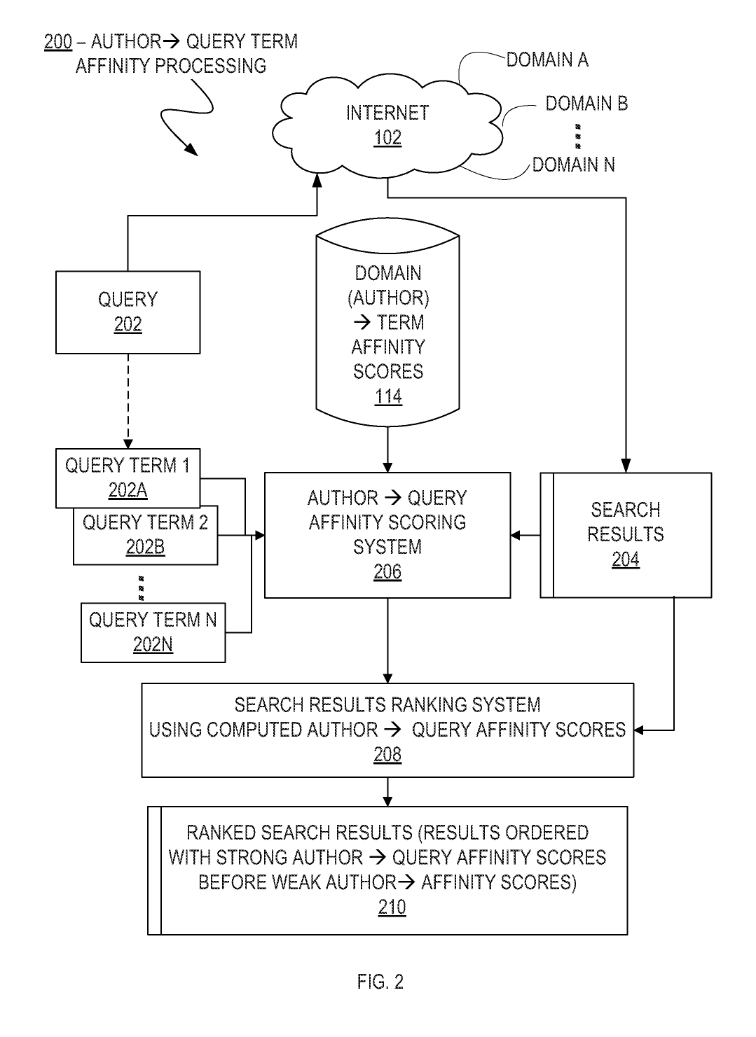

In one embodiment, an author-term affinity scoring system 112 extracts from the corpus 106 and the data structure within the corpus, a collection of source domain—anchor text—destination domain triplets 108, in which the source domain is the hosting domain of the item that contains the anchor text, and the destination domain is the hosting domain of the item to which the anchor text is linked. During processing, the author term affinity scoring system 112 obtains the current domain (author) influence scores 110 associated with the source and destination domains, and updates a destination domain's influence score based on the collective influence of all of the source domains of pages containing anchor texts that link to that destination domain. In addition, the author-term affinity scoring system 112 uses the updated destination domains' influence scores to generate more granular influence scoring information in the form of a repository of author-term affinity scores 114 for each author (destination domain) and anchor text term combination encountered in the corpus. As will be described in further detail with reference to FIG. 2, the embodiments described herein use the updated domain influence scores 110 and author term affinity scores 114 for use in ranking search results so that items hosted by domains with greater influence are ranked higher than items hosted by domains with lesser influence.

FIG. 2 is a block diagram illustrating an example of one or more data processing systems author—query affinity processing 200, in which the generated author term affinity scores 114 are input to the author query affinity scoring system along with the query 202 having one or more query terms 202A, 202B, . . . 202N.

In one embodiment, for a set of search results 204 of items hosted by Domains A, B . . . N, returned by a search engine via Internet 102 the processing 200 computes 206 an author-query affinity score based on the author term affinity scores 114 and the query terms 1, 2, . . . N contained in the query 202. A search results ranking system 208 uses the computed author-query affinity score to rank the search result items and presents the ranked search results 210 to the user such that items with strong author-query affinity scores are ranged before items with weak author-query affinity scores.

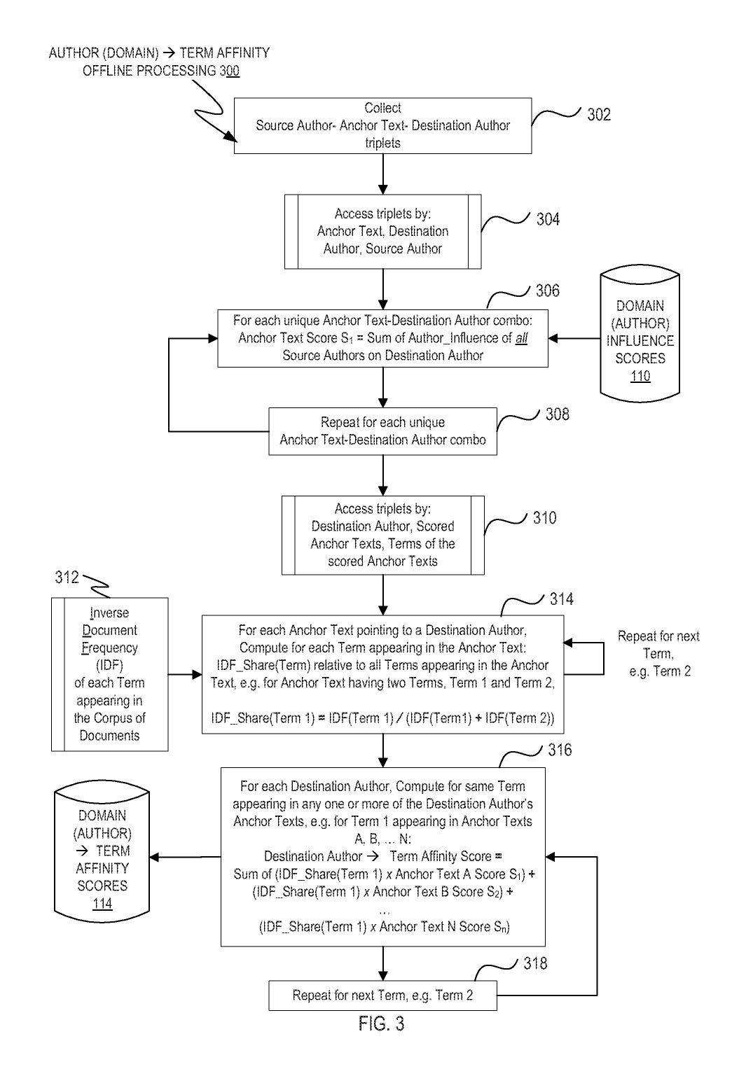

FIG. 3 is a flow diagram illustrating a process 300 for creating the author-term affinity scores 114 in accordance with one embodiment. For example, the process 300 first collects all of the source author (domain)—anchor text—destination author (domain) triplets 302. The process 300 accesses the triplets first by anchor text, destination author and source author 304 and, for each unique anchor text—destination author combination, obtains the current domain influence scores 110 of all source authors and the destination author. In one embodiment, the process 300 computes the anchor text's score S₁ as the sum of the author influence of all of the source authors on the destination author.

For example, if web pages hosted by Domain A, Domain B and Domain C all contain anchor text that points to a page hosted by Domain D, then the author influence scores for Domain A, Domain B and Domain C are used to update the author influence score for Domain D. In a typical embodiment, updating the author influence score for Domain D will increase the score, meaning the influence of Domain D will be stronger. However, in some instances, updating the author influence score for Domain D could, in fact, decrease the score, such as when one of the source domains is a blacklisted domain having a negative influence on all destination domains with which it is linked. The process of updating the author influence scores for the destination authors continues at 308 until all of the anchor text-destination domain combinations have been processed.

In one embodiment, once all of the anchor texts—destination domain combinations have been processed and the author influence of the destination domains updated, then process 300 continues to prepare for generating the author-term affinity scores. At 310, after obtaining all of the scored anchor texts pointing to a particular destination domain, then at 314 for each term appearing in the scored anchor texts, the process 300 obtains the IDF of the term, where the IDF is the inverse document frequency of the term in the corpus. Using each term's IDF, the process 300 computes the IDF share of the term relative to all of the other terms appearing in the scored anchor texts that point to the particular destination domain. By way of example only, the IDF share of the term can be expressed as:

IDF Share(Term 1)=IDF(Term 1)/(IDF(Term 1)+IDF(Term 2))

for scored anchor texts in which two terms appear. In actual practice, the number of terms appearing in the scored anchor texts that point to the particular destination domain can include more than two terms.

In one embodiment, upon computing the IDF share of the terms appearing in the anchor texts, the process 300 concludes by computing the author—term affinity score for the destination domain and each term appearing in any one or more of the scored anchor texts that point to the destination domain, e.g. for Term 1 appearing in any one or more anchor texts A, B and C for destination domain A, for Term 2 appearing in any one or more anchor texts A, B and C for destination domain A, and so forth, until all Terms 1 . . . Term N that appear the anchor texts for destination domain A have been processed.

In one embodiment the author—term affinity score for the destination domain is computed from the product of the IDF share of a term and the anchor text score Sᵢ of each anchor text in which the term appears and that points to the destination domain, and summing the products together. By way of example only, author-term affinity score for Term 1 appearing in anchor texts A, B, . . . N can be expressed as:

$$Author \text{-} term affinity score = IDF share ( Term 1 \times Anchor Text A Score {S}_{1} + IDF share ( Term 1 \times Anchor Text B Score {S}_{2} + IDF share ( Term 1 \times Anchor Text N Score {S}_{n}$$

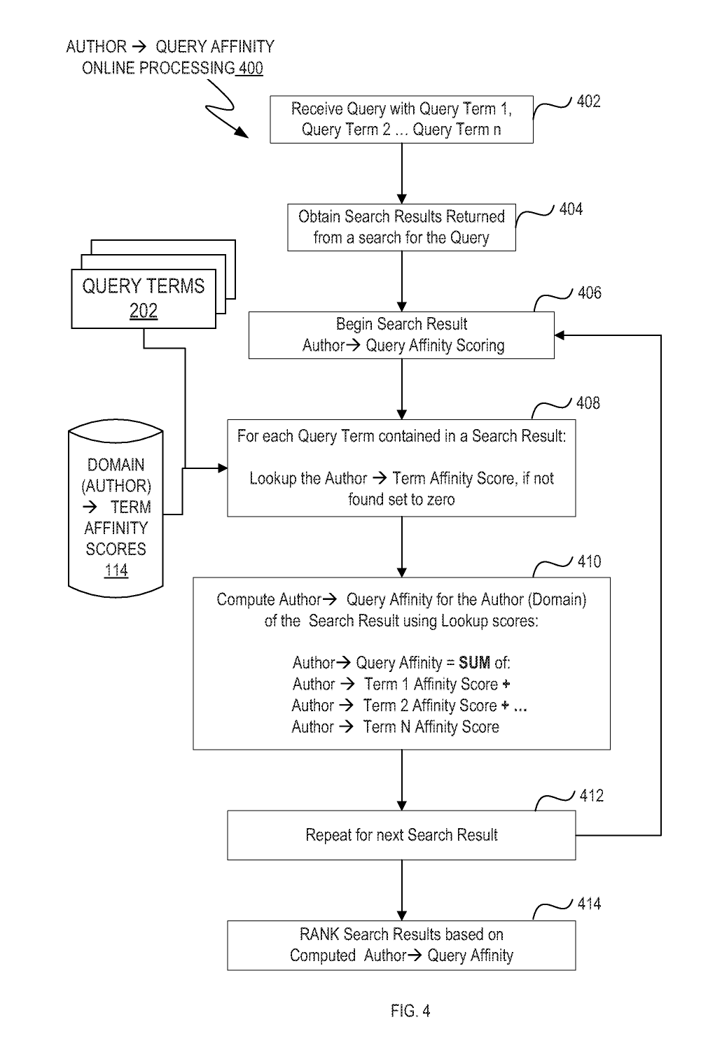

In one embodiment, the process 316 is repeated for the next term, e.g. Term 2 that appears in any one or more of the anchor texts that point to the destination domain until an author-term affinity score for each term has been computed. The processes 310 through 316 are repeated for each destination domain encountered in the corpus for which anchor text scores have been computed until the author-term affinity scores for all destination domains have been completed. In one embodiment, the author term affinity scores are stored in a repository 114 for future use in processing searches against the corpus, including ranking search results as will be described in further detail with reference to FIG. 4.

FIG. 4 is a flow diagram that illustrates processes for ranking search results using author-term affinity scores in accordance with one or more embodiments described herein. The process 400 receives a query having one or more terms for which to obtain search results at 404. At 406, the process 400 begins a processing loop 406-412 for scoring the author-query affinity, where the author-query affinity quantifies the influence of the author of the items in the search result in relationship to the terms of the query. Thus, at 408, for each query term 202 contained in an item returned by the search in the search result, the process 400 performs a lookup of the author of the item in which the query term is contained to determine whether there is a match on the item's author/query term combination in the author term affinity score repository 114. If so, then at 410 the process 400 computes the author-query affinity for the author of the item in the search result using the lookup scores. By way of example only, author-query affinity score for Query Terms 1, 2, . . . N appearing in items authored by a particular destination domain can be expressed as:

$$Author \text{-} query affinity score = Author \text{-} Term 1 affinity score + Author \text{-} Term 2 affinity score + … Author \text{-} Term N affinity score .$$

The processes 406-412 are repeated for each item appearing in a search result until the authors of all items appearing in the search result have been scored with an author-query affinity score. Then, at 414, the process 400 concludes with ranking the search results based on the computed author-query affinity scores.

In one embodiment, the processes illustrated in FIGS. 3-4 can be performed for domains in which a social network or social media domain is divided into a subset of domains based upon the different authors or other contributors to the social network or social media domain. For example, each author in a Facebook domain or each author in a Twitter domain can be treated as a separate domain distinct from the host domain (e.g., the Facebook domain) and separate and distinct from other authors in the same social network domain. An author can represent anyone who authors or contributes to content in the subdomain. For example a social network domain can host a variety of different authors each of which post (e.g. contribute or author) content on the social network domain which hosts the content. For example, one author might post content on a page or wall of a Facebook domain. In this scenario, each contributing author is treated as a separate and distinct domain and processed as described herein.

The embodiments described herein may be applicable to various different types of data including, for example, web pages in the Internet, pages in a social network, content in social media, and even searching within an application (app) which may not be a web browser app. For example, many apps can provide for searching within the app or application, and those search results can be ranked using the techniques described herein to provide a safer or more secure set of search results for use within the application.

The systems and methods described herein can be implemented in a variety of different data processing systems and devices, including general-purpose computer systems, special purpose computer systems, or a hybrid of general purpose and special purpose computer systems. Exemplary data processing systems that can use any one of the methods described herein include server systems, desktop computers, laptop computers, embedded electronic devices, or consumer electronic devices.

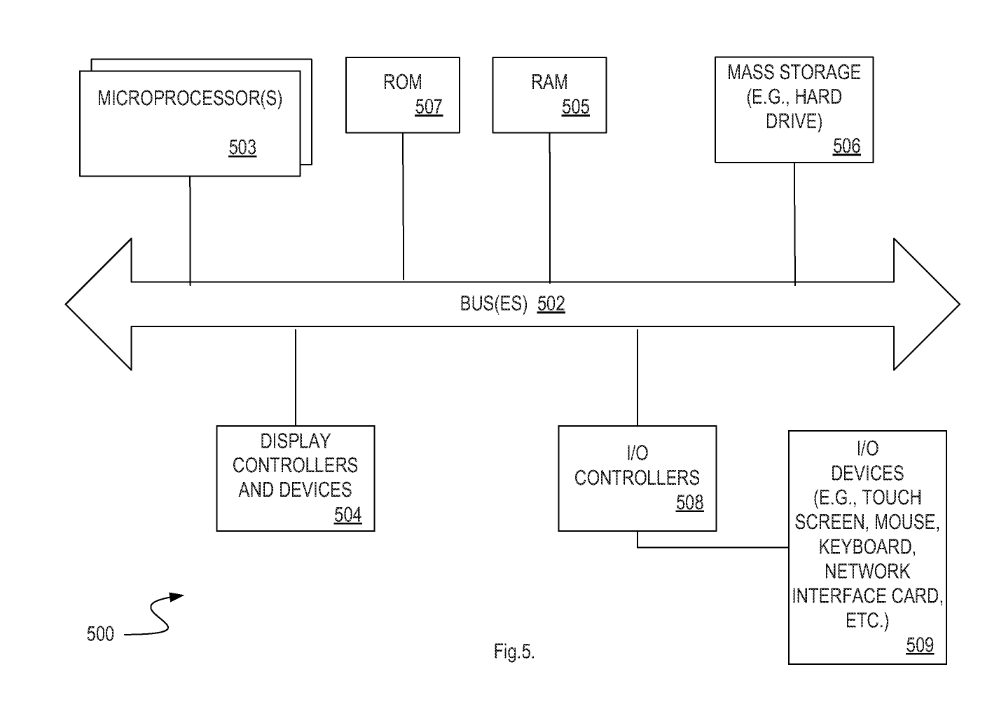

FIG. 5 is a block diagram of data processing system hardware according to an embodiment. Note that while FIG. 5 illustrates the various components of a data processing system that may be incorporated into a server system or other computer system, it is not intended to represent any particular architecture or manner of interconnecting the components as such details are not germane to the present invention. It will also be appreciated that other types of data processing systems that have fewer components than shown or more components than shown in FIG. 5 can also be used with the present invention.

As shown in FIG. 5, the data processing system includes one or more buses 509 that serve to interconnect the various components of the system. One or more processors 503 are coupled to the one or more buses 509 as is known in the art. Memory 505 may be DRAM or non-volatile RAM or may be flash memory or other types of memory or a combination of such memory devices. This memory is coupled to the one or more buses 509 using techniques known in the art. The data processing system can also include non-volatile memory 507, which may be a hard disk drive or a flash memory or a magnetic optical drive or magnetic memory or an optical drive or other types of memory systems that maintain data even after power is removed from the system. The non-volatile memory 507 and the memory 505 are both coupled to the one or more buses 509 using known interfaces and connection techniques. A display controller 522 is coupled to the one or more buses 509 in order to receive display data to be displayed on a display device 523. The display device 523 can include an integrated touch input to provide a touch screen. The data processing system can also include one or more input/output (I/O) controllers 515 which provide interfaces for one or more I/O devices, such as one or more mice, touch screens, touch pads, joysticks, and other input devices including those known in the art and output devices (e.g. speakers). The input/output devices 517 are coupled through one or more I/O controllers 515 as is known in the art.

While FIG. 5 shows that the non-volatile memory 507 and the memory 505 are coupled to the one or more buses directly rather than through a network interface, it will be appreciated that the present invention can utilize non-volatile memory that is remote from the system, such as a network storage device which is coupled to the data processing system through a network interface such as a modem or Ethernet interface. The buses 509 can be connected to each other through various bridges, controllers and/or adapters as is well known in the art. In one embodiment the I/O controller 515 includes one or more of a USB (Universal Serial Bus) adapter for controlling USB peripherals, an IEEE 1394 controller for IEEE 1394 compliant peripherals, or a Thunderbolt controller for controlling Thunderbolt peripherals. In one embodiment, one or more network device(s) 1325 can be coupled to the bus(es) 509. The network device(s) 525 can be wired network devices (e.g., Ethernet) or wireless network devices (e.g., WI-FI, Bluetooth).

It will be apparent from this description that aspects of the present invention may be embodied, at least in part, in software. That is, the techniques may be carried out in a data processing system in response to its processor executing a sequence of instructions contained in a storage medium, such as a non-transitory machine-readable storage medium (e.g. DRAM or flash memory). In various embodiments, hardwired circuitry may be used in combination with software instructions to implement the present invention. Thus the techniques are not limited to any specific combination of hardware circuitry and software, or to any particular source for the instructions executed by the data processing system. Moreover, it will be understood that where mobile or handheld devices are described, the description encompasses mobile devices (e.g., laptop devices, tablet devices), handheld devices (e.g., smartphones), as well as embedded systems suitable for use in wearable electronic devices.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

What is claimed is:

1. A method for creating author-term affinity scores that can be used to rank search results, the method comprising:
obtaining a corpus of pages hosted by a set of domains, the set of domains including source domains and destination domains, the source domains hosting pages containing anchor texts linked to pages hosted by the destination domains;
collecting anchor texts contained in pages hosted by well-represented source domains;
updating destination author influence scores with source author influence scores based on the links in the collected anchor texts;
computing an anchor text score for each anchor text in the collected anchor texts based on the updated destination author influence score;
computing an author-term affinity score between a destination domain and a term in the collected anchor texts, the author-term affinity score based on a contribution of the term to an anchor text's score for all anchor texts in the collected anchor texts in which the term appears.

2. The method as in claim 1, further comprising:
returning a result set of pages in the corpus of pages responsive to receiving a query;
for each searched domain hosting a page in the result set of pages and each query term in the query, obtaining the computed author-term affinity score for each searched domain and query term combination;
computing an author-query affinity score between the searched domain and the query based on a sum of all of the computed author-term affinity scores for the searched domain and query term combinations; and
ranking the page in the result set of pages based on the computed author-query affinity score of the searched domain hosting the page.

3. The method as in claim 1, further comprising:
computing the contribution of the term in the anchor text to the anchor text's score based on how frequently the term occurs in the corpus of documents.

4. The method as in claim 3, wherein how frequently the term occurs in the corpus of documents is based on the term's inverse document frequency (IDF).

5. The method as in claim 1, wherein updating destination author influence scores with source author influence scores based on the links in the collected anchor texts includes counting the links from the source domains hosting the pages containing anchor texts to the pages hosted by the destination domains.

6. The method of claim 1 wherein the pages are web pages and a domain in the set of domains is defined by a set of web addresses or Uniform Resource Identifiers owned or controlled by an entity.

7. The method of claim 6, the method comprising:
crawling the Internet to obtain and store the corpus.

8. The method of claim 1 wherein each page is a discreet set of content at a specified URI (Uniform Resource Identifier).

9. The method of claim 1, wherein authors of pages hosted by source domains and destination domains are treated as domains separate from the hosting domain.

10. The method of claim 9, wherein the hosting domain includes at least one of social media or social network web sites.

11. A non-transitory machine readable medium storing instructions which when executed by one or more data processing systems cause the one or more systems to perform a method for creating author-term affinity scores that can be used to rank search results, the method comprising:
obtaining a corpus of pages hosted by a set of domains, the set of domains including source domains and destination domains, the source domains hosting pages containing anchor texts linked to pages hosted by the destination domains;
collecting anchor texts contained in pages hosted by well-represented source domains;
updating destination author influence scores with source author influence scores based on the links in the collected anchor texts;
computing an anchor text score for each anchor text in the collected anchor texts based on the updated destination author influence score;
computing an author-term affinity score between a destination domain and a term in the collected anchor texts, the author-term affinity score based on a contribution of the term to an anchor text's score for all anchor texts in the collected anchor texts in which the term appears.

12. The medium as in claim 11, the method further comprising:
returning a result set of pages in the corpus of pages responsive to receiving a query;
for each searched domain hosting a page in the result set of pages and each query term in the query, obtaining the computed author-term affinity score for each searched domain and query term pair;
computing an author-query affinity score between the searched domain and the query based on a sum of all of the computed author-term affinity scores for the searched domain and query term pairs; and
ranking the page in the result set of pages based on the computed author-query affinity score of the searched domain hosting the page.

13. The medium as in claim 11, further comprising:
computing the contribution of the term in the anchor text to the anchor text's score based on how frequently the term occurs in the corpus of documents.

14. The medium as in claim 13, wherein how frequently the term occurs in the corpus of documents is based on the term's inverse document frequency (IDF).

15. The medium as in claim 11, wherein updating destination author influence scores with source author influence scores based on the links in the collected anchor texts includes counting the links from the source domains hosting the pages containing anchor texts to the pages hosted by the destination domains.

16. The medium as in claim 11, wherein the pages are web pages and a domain in the set of domains is defined by a set of web addresses or Uniform Resource Identifiers owned or controlled by an entity.

17. The medium as in claim 16, the method comprising:
crawling the Internet to obtain and store the corpus.

18. The medium as in claim 11, wherein each page is a discreet set of content at a specified URI (Uniform Resource Identifier).

19. The medium as in claim 11, wherein authors of pages hosted by source domains and destination domains are treated as domains separate from the hosting domain.

20. The medium as in claim 19, wherein the hosting domain includes at least one of social media or social network web sites.

21. A method for ranking search results, the method comprising:
obtaining a corpus of pages hosted by a set of domains, the set of domains including source domains and destination domains, the source domains hosting pages containing anchor texts linked to pages hosted by the destination domains;
returning a result set of pages in the corpus of pages responsive to receiving a query;
for each searched domain hosting a page in the result set of pages and each query term in the query:
obtaining an author-term affinity score previously computed for each searched domain and query term pair from one or more source-anchor-destination triplets extracted from the corpus of pages,
computing an author-query affinity score between the searched domain and the query based on a sum of all of the computed author-term affinity scores for the searched domain and query term pairs; and
ranking the page in the result set of pages based on the computed author-query affinity score of the searched domain hosting the page.

22. The method as in claim 21, wherein the author-term affinity score is computed based on a combination of an inverse document frequency (IDF) share of each term in one or more anchor texts and an influence score of the source domain hosting pages containing a term in the one or more anchor texts, the IDF representing how frequently the term occurs in the corpus of documents.

23. The method as in claim 21, further comprising:
creating the author-term affinity scores any one of periodically or on-demand, including:
collecting anchor texts contained in pages hosted by well-represented source domains;
updating one or more previously stored destination author influence scores with source author influence scores based on the links in the collected anchor texts;
computing an anchor text score for each anchor text in the collected anchor texts based on the updated destination author influence score; and
computing an author-term affinity score between a destination domain and a term in the collected anchor texts, the author-term affinity score based on a contribution of the term to an anchor text's score for all anchor texts in the collected anchor texts in which the term appears.

24. The method as in claim 23, wherein updating destination author influence scores with source author influence scores based on the links in the collected anchor texts includes counting the links from the source domains hosting the pages containing anchor texts to the pages hosted by the destination domains.

25. The method as in claim 23, wherein the pages are web pages and a domain in the set of domains is defined by a set of web addresses or Uniform Resource Identifiers owned or controlled by an entity.
